(19) United States
(12) Patent Application Publication
(10) Pub. No.: US 2017/0061447 A1
(43) Pub. Date: Mar. 2, 2017

(54) MARKETING SYSTEM OF COLLECTING AND EXCHANGING POINT

(71) Applicants: Fu-Kuang Wang, Taipei City (TW); Hsiang-Chun Tseng, Taipei City (TW); Li-Hua Huang, (US); Chih-Chang Lin, Taipei City (TW); Chin-Yu Chen, Taipei City (TW)

(72) Inventors: Fu-Kuang Wang, Taipei City (TW); Chih-Chang Lin, Taipei City (TW)

(21) Appl. No.: 14/836,962

(22) Filed: Aug. 27, 2015

(51) Int. Cl. G06Q 30/02

(52) U.S. Cl. CPC G06Q 30/0201

(57) ABSTRACT

A marketing system of collecting and exchanging point includes a server side device, a plurality of shop side devices, and a plurality of consumption side devices. The server side device stores shop accounts, information of collecting and exchanging point, customer accounts, and customer point information. Each shop side device is respectively corresponding to one shop account. Each consumption side device is respectively corresponding to one customer account. Each consumption side device respectively has a point collecting module and a point exchanging module for executing a point collecting action and a point exchanging action. The server side device gathers and computes exchangeable points being collected and exchanged with regard to a plurality of the shop accounts. The exchangeable points of the customer account are divided into a plurality of exchangeable points specialized for each of the shop accounts.

### (A) TECHNICAL FIELD OF THE INVENTION

The present invention relates generally to a marketing system, and more particularly to a marketing system of collecting and exchanging point that connects a back-end platform of a shop for automatically controlling customer relationship management and broadcast marketing system.

### (B) DESCRIPTION OF THE PRIOR ART

Now with a fiercely competitive market, how a shop attracts customers and maintains customers' loyalty has become an important task for success or failure. Presently, most shops adapt a method that transforms commodity shopping record into reward points in order to encourage customers to by commodities for collecting the reward points so as to exchange for other commodities. By such method, regular customers may go the shop more frequently and the mount of new customers may increase.

Conventional method of collecting and exchanging point generally is that individual shop respectively provides customers with reward points (hereinafter referred as exchangeable points) of individual shop, so that the customers can exchange for commodities or largess from the shop. However, it is very inconvenience that the customer carries variety of exchangeable points of various individual shops at all the times. Also, customers usually do not note which shop they have its exchangeable points. Therefore, conventional method of collecting and exchanging point is not applicable with regard to customers' habits in the mobile age. Further, customers usually prefer that many shops can be chosen, and be usually curious to go to new shops. If customers move to another shop, shops with same property may repel each other that causes the exchangeable points of those shops cannot be completely used, so that the customers' desire for collecting point may decrease and thus the aims of attracting customers and maintaining customers' loyalty still cannot be achieved by means of the conventional method.

### SUMMARY OF THE INVENTION

The primary object of the present invention is to provide a marketing system of collecting and exchanging point including a server side device, a plurality of shop side devices, and a plurality of consumption side devices. The server side device stores a plurality of shop accounts and information of collecting and exchanging point thereof, and stores a plurality of customer accounts and customer point information thereof. A plurality of the shop side devices is connected with the server side device through a network, each of the shop side devices is respectively corresponding to one of the shop accounts. A plurality of the consumption side devices is connected with the server side device through the network, each of the consumption side devices is respectively corresponding to one of the customer accounts, each of the consumption side devices respectively has a point collecting module and a point exchanging module for having a customer executing a point collecting action by means of the point collecting module and executing a point exchanging action by means of the point exchanging module in exchange for a commodity of the information of collecting and exchanging point, through the server side device, based on exchangeable points included in the customer point information of the customer account. The server side device gathers and computes the exchangeable points being collected and exchanged with regard to a plurality of the shop accounts by the customer by means of the consumption side device to update the exchangeable points included in the customer point information of the customer account. The exchangeable points included in the customer point information of the customer account are divided into a plurality of exchangeable points specialized for each of the shop accounts.

Preferably, the consumption side device further includes a point transforming module for having the customer executing a point transforming action, by means of the point transforming module, that transforms, based on the exchangeable points included in the customer point information of the customer account, the exchangeable points specialized for one of the shop accounts into the exchangeable points specialized for another of the shop accounts.

Preferably, the shop side device further includes a point transforming record displaying module displaying a transforming record information, related to the shop account of the shop side device, generated by the point transforming action executed by the point transforming module of the consumption side device.

Preferably, the shop side device further includes a point sending module for having a shop sending, by means of the point sending module, the exchangeable points specialized for the shop accounts of the shop, through the server side device, into the customer point information of the customer account.

Preferably, consumption side device further includes a point sending module for having the customer sending, by means of the point sending module, exchangeable points of shop included in the customer point information of the customer account, through the server side device, into the customer point information of another customer account.

Preferably, the point exchanging module automatically executes the point exchanging action in a code scanning manner.

Preferably, the point collecting module automatically executes the point collecting action in a code scanning manner.

Preferably, the shop side device further includes a broadcasting module for having a shop broadcasting a message, through the server side device, to the consumption side device by means of the broadcasting module.

Preferably, the shop side device further includes an exchange setting module for having a shop setting the information of collecting and exchanging point of the shop account of the shop, through the server side device, by means of the exchange setting module.

Preferably, the shop side device further includes a consumption amount inputting module, and the server side device updates the exchangeable points specialized for the shop accounts, which are included in the customer point information of the customer account, according to a consumption amount of the customer account inputting in the consumption amount inputting module by a shop and according to the information of collecting and exchanging point of the shop account of the shop.

By means of the present invention, the exchangeable points which are collected and exchanged with regard to a plurality of the shop accounts by the customer are gathered and computed, and the exchangeable points owned by the customer account are divided into a plurality of exchangeable points specialized for each of the shop accounts. Therefore, a new method of collecting and exchanging point is generated that exchangeable points being collected and exchanged with regard to a plurality of the shops can be horizontally transferred between different shops so as to prevent shops with same property from repelling each other and to maximize point exchange in the market. The present invention provides the function to let each consumer can freely move the collected point from one shop to another, also, send the collected point to other consumer for the purpose to encourage more customers come to the shop for helping the shop grab more business chances. Thus, the customers' desire for collecting point increases, so that customers certainly can be attracted by this method of collecting and exchanging point.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing equipment involved in an embodiment of the present invention.

FIG. 2 is a schematic view showing system architecture of the embodiment of the present invention.

FIGS. 3A to 3L are schematic views showing screens of customer side devices of the embodiment of the present invention.

FIGS. 4A to 4D are schematic views showing screens of shop side devices of the embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

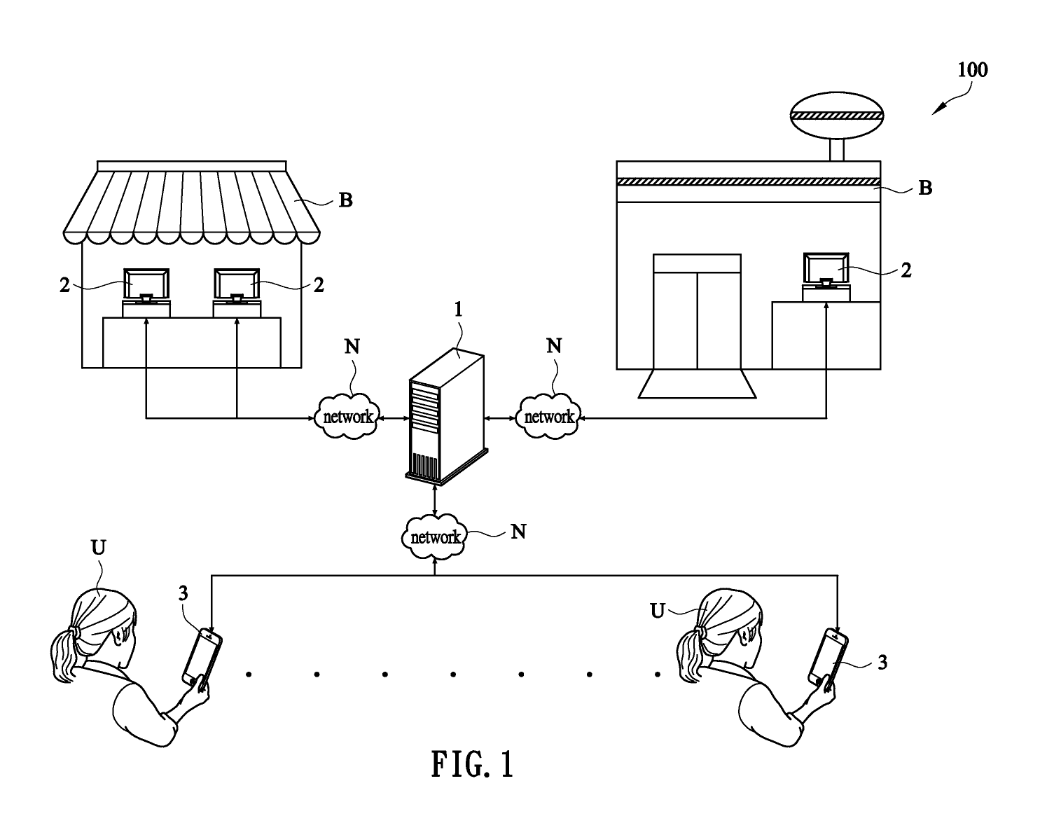

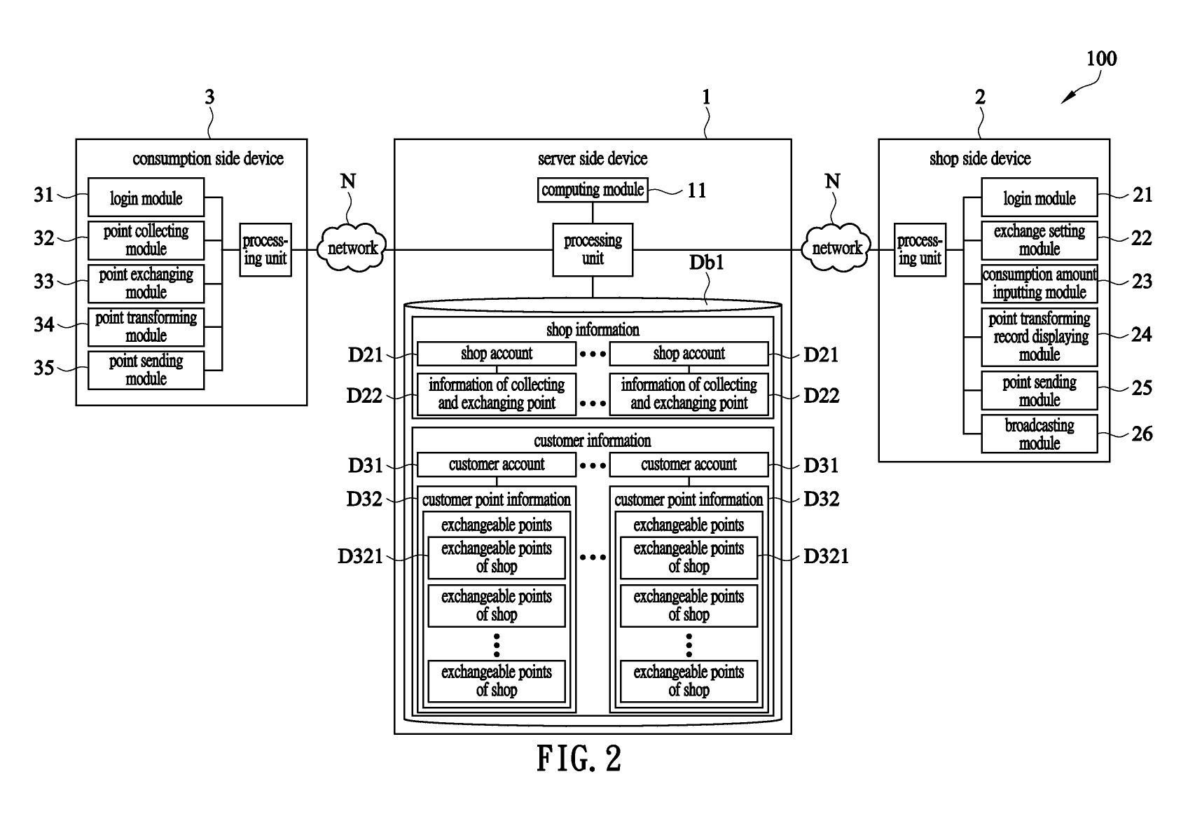

Referring to FIGS. 1 and 2, the present invention provides a marketing system of collecting and exchanging point 100 including a server side device 1, a plurality of shop side devices 2, and a plurality of consumption side devices 3.

The database Db1 of the server side device 1 stores a plurality of shop accounts D21 and information of collecting and exchanging point D22 thereof, and stores a plurality of customer accounts D31 and customer point information D32 thereof.

The shop side devices 2 are connected with the server side device 1 through a network N, each of the shop side devices 2 is respectively corresponding to one of the shop accounts D21 in the database Db1. The shop side device can be a computer provided at a shop B, or the like, so that a shop B can login in the shop side device 2 by inputting the shop account D21 and the password of the shop B by means of a login module 21.

The consumption side devices 3 are connected with the server side device 1 through the network N, each of the consumption side devices 3 is respectively corresponding to one of the customer accounts D31 in the database Db1. The consumption side devices 3 can be an electronic device held by a customer U, such as a smart phone, so that the customer U can login in the consumption side devices 3 by inputting the customer accounts D31 of the customer U by means of a login module 31.

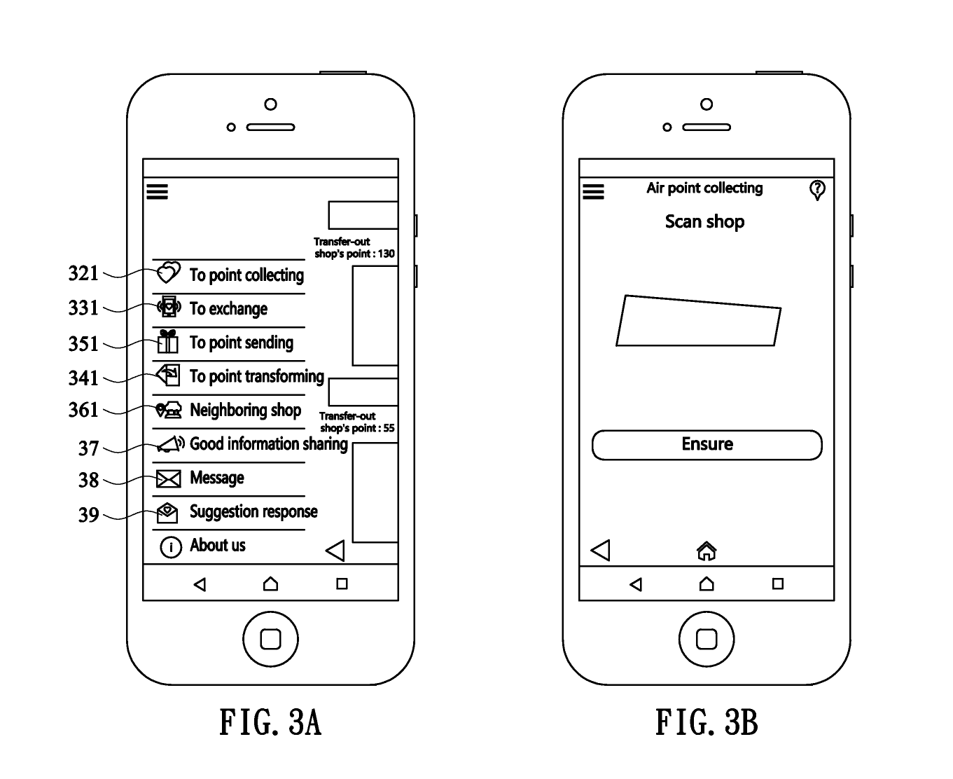

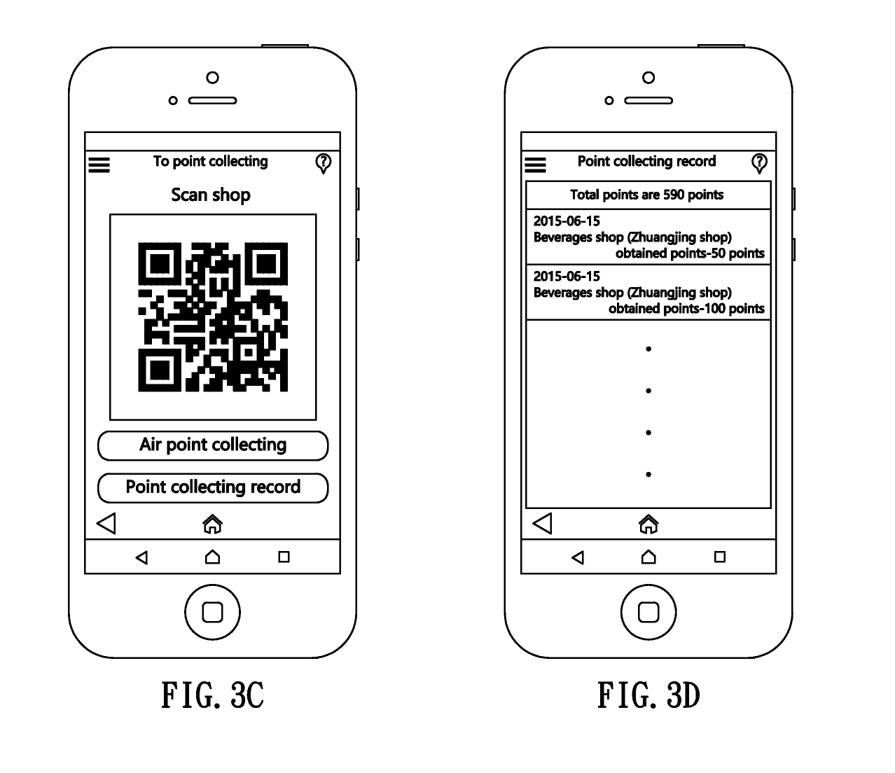

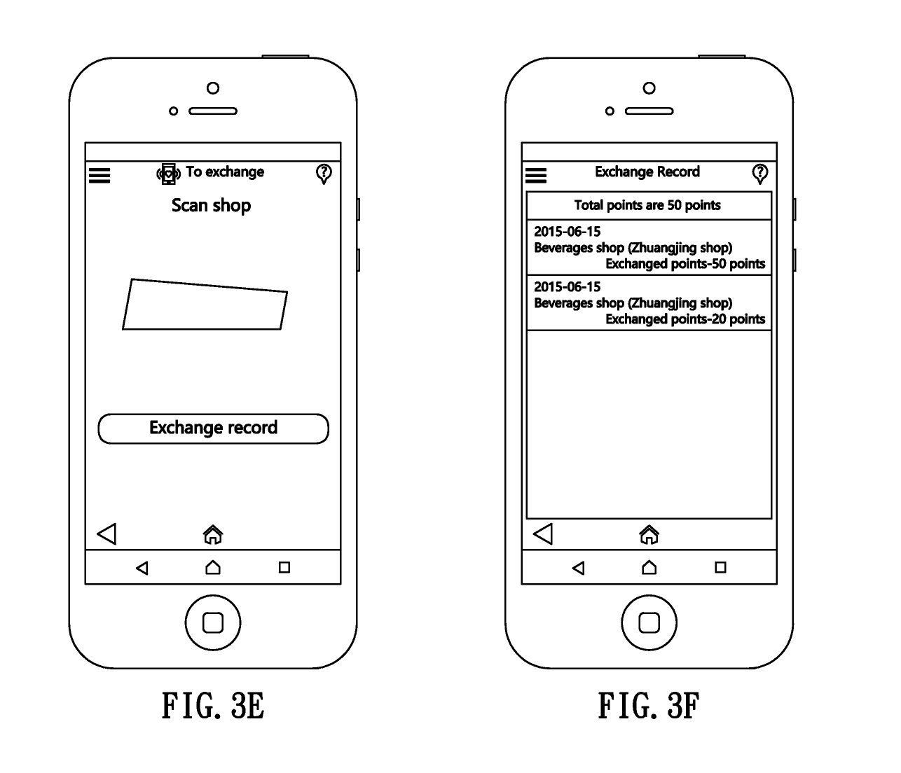

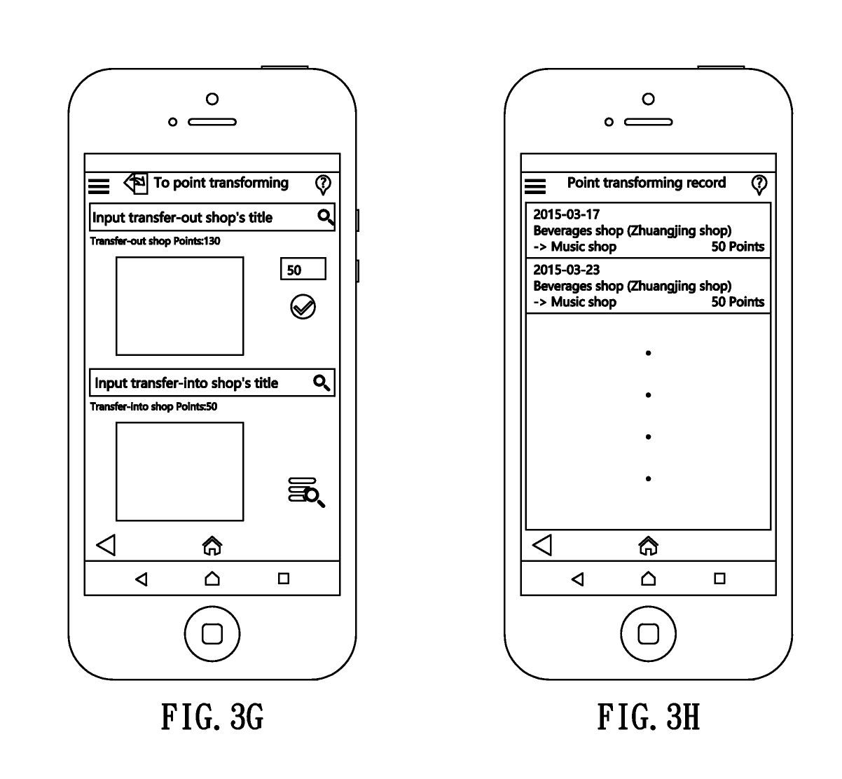

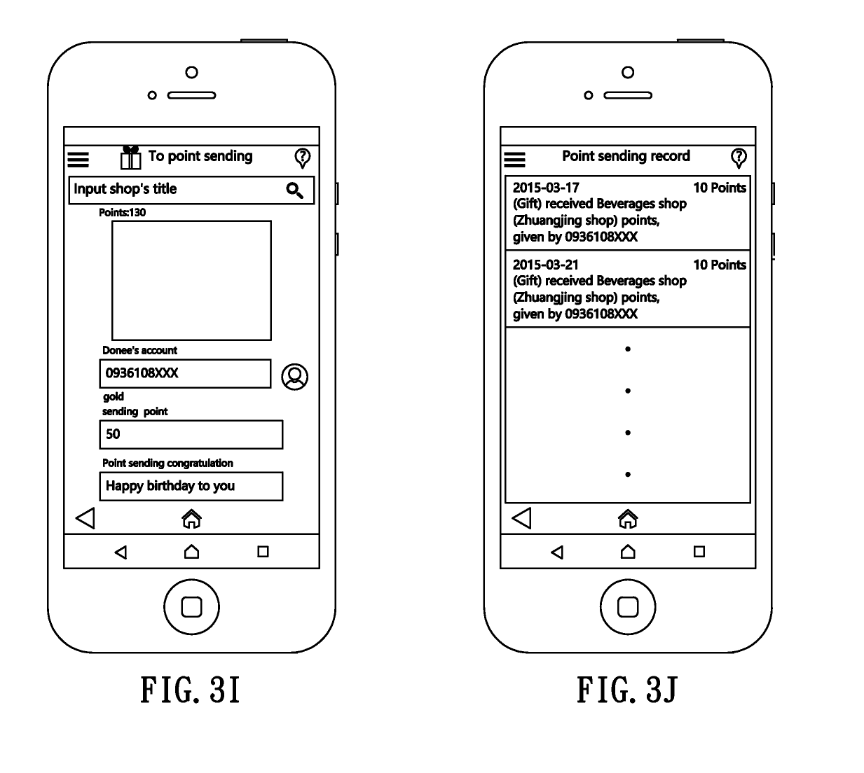

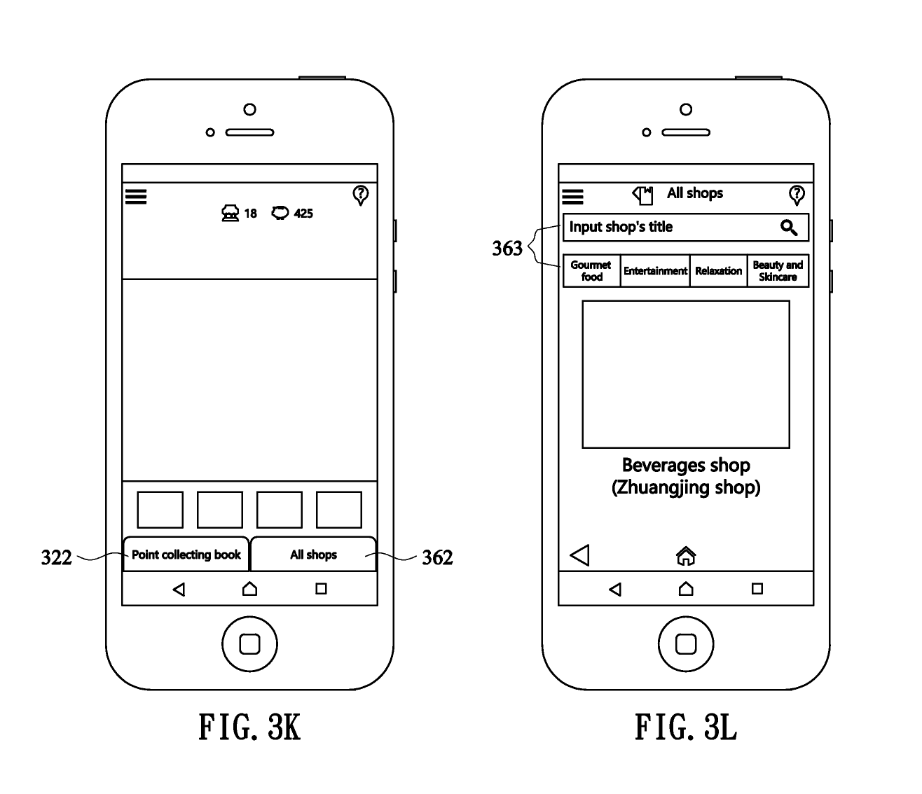

Each of the consumption side devices 3 respectively has a point collecting module 32 and a point exchanging module 33 for having a customer U executing a point collecting action by means of the point collecting module 32 to collect exchangeable points of the information of collecting and exchanging point D22 of a plurality of the shop accounts D21 through the network N. The exchangeable points included in the customer point information D32 of the customer account D31 of the customer U are divided, according to a plurality of the shop accounts D21, into a plurality of exchangeable points D321 specialized for each of the shop accounts D21. In other words, the customer U can collect exchangeable points of shop D321 from different shops B by means of the consumption side devices 3. Specifically, the customer U can click a point collecting member 321 of a main menu (FIG. 3A) and then the point collecting module 32 automatically executes the point collecting action in a code scanning manner. For example, the point collecting action can be executed by the consumption side device 3, at a shop B, which scans a code information (FIG. 3B) of the shop B. Alternatively, the point collecting action can be executed by the shop side device 2 which scans a code information of the customer account D31 displayed on the consumption side device 3 (FIG. 3C). Also, the point collecting record can be displayed on the consumption side device 3 (FIG. 3D).

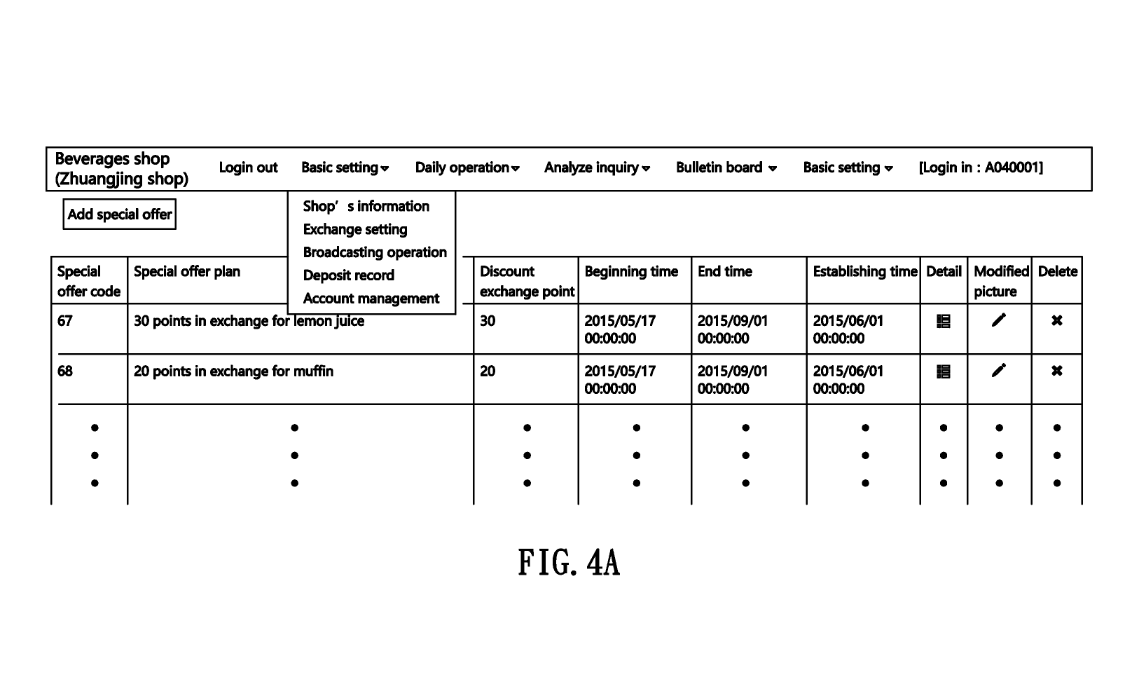

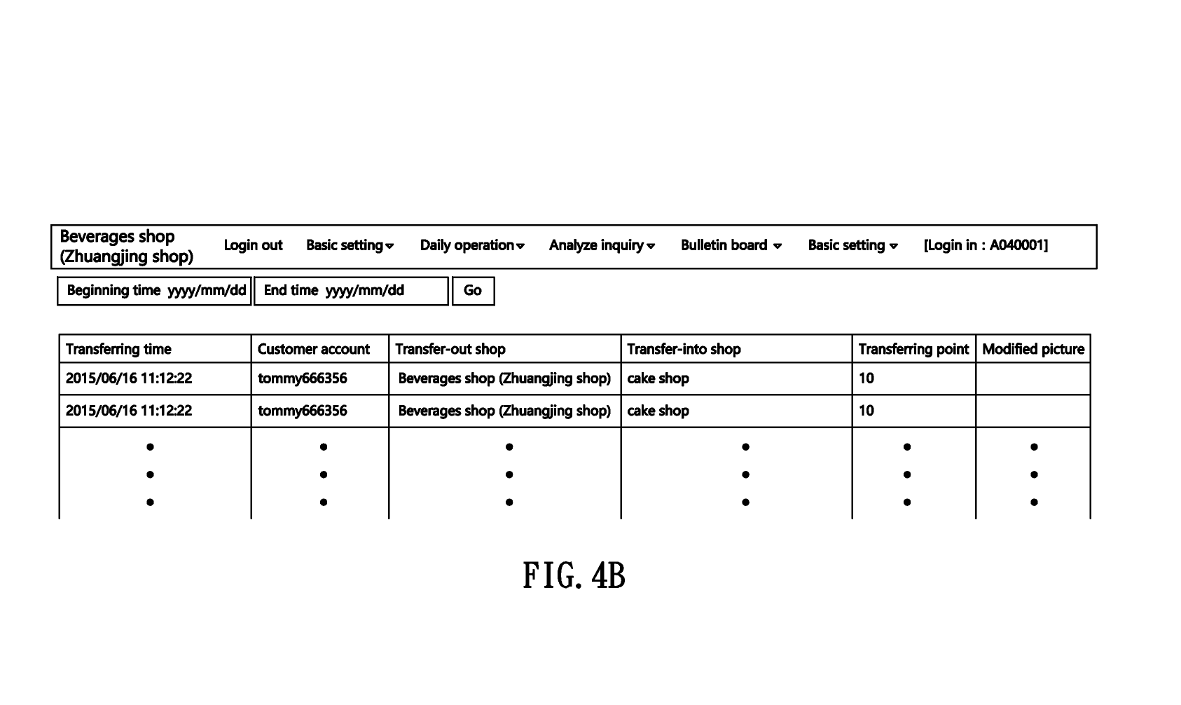

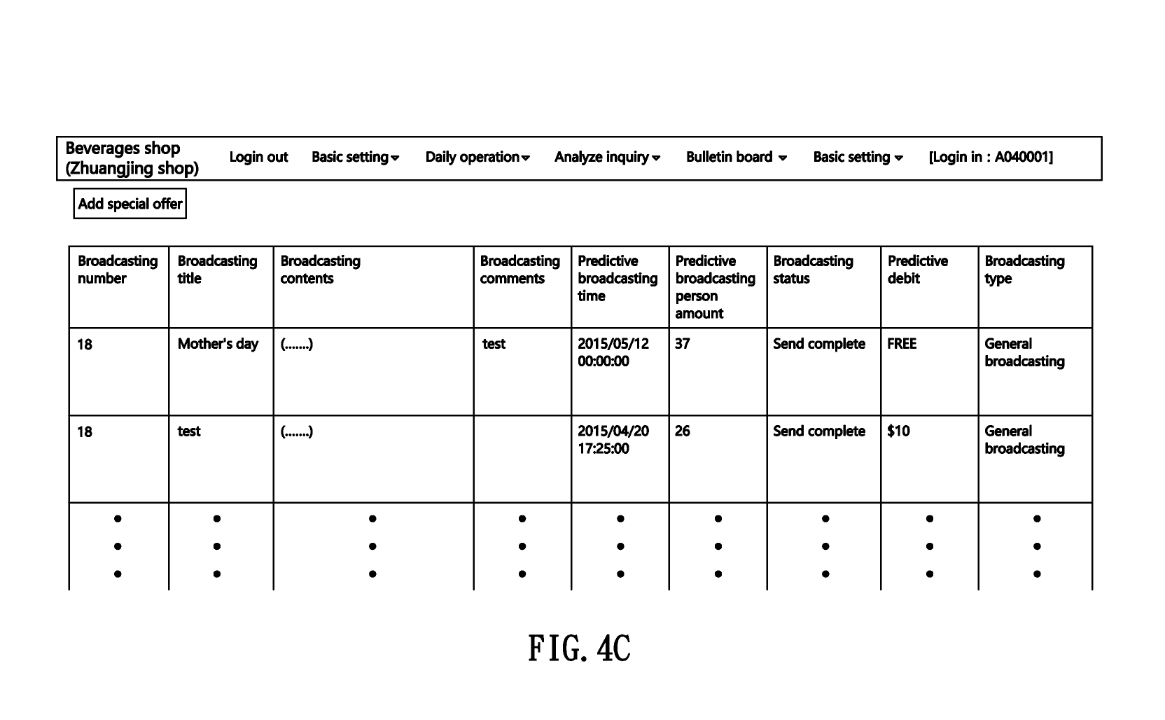

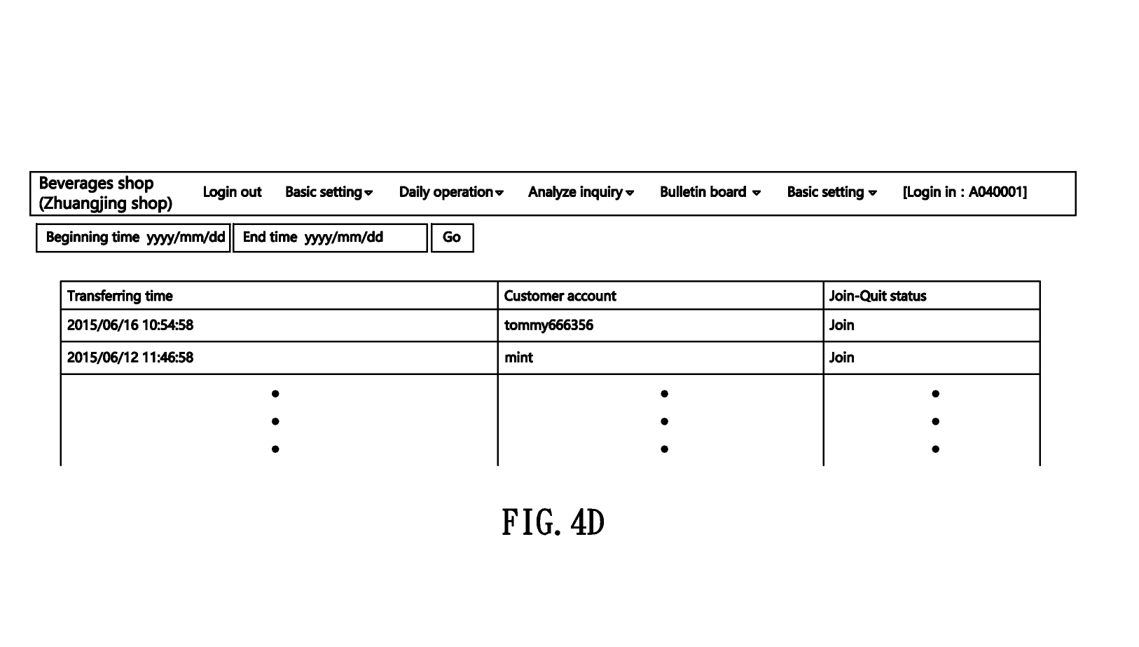

The customer D also can executes a point exchanging action by means of the point exchanging module 33 in exchange for a commodity of the information of collecting and exchanging point D22 of a plurality of the shop accounts D21, through the server side device 1, based on exchangeable points included in the customer point information D32 of the customer account D31. In other words, the customer U must use the exchangeable points D321 specialized for certain shop account D21 in exchange for a commodity of the information of collecting and exchanging point D22 of the shop account D21. Specifically, the customer U can click a point exchanging member 331 of the main menu (FIG. 3A) and then the point exchanging module 33 automatically executes the point exchanging action in a code scanning manner. For example, the point exchanging action can be executed by the consumption side device 3, at a shop B, which scans a code information of the shop B (FIG. 3E). The point exchanging record also can be displayed on the consumption side device 3 (FIG. 3F). On the other hand, the shop side device 2 further includes an exchange setting module 22 for having a shop B setting the information of collecting and exchanging point D22 of the shop account D21 of the shop B, through the server side device 1, by means of the exchange setting module 22, as shown in FIG. 4A, the shop B can set the information of collecting and exchanging point D22, such as special offers, discount exchangeable points, and the beginning/end time of the special offers, by means of the exchange setting module 22.

After the point collecting action and the point exchanging action, a computing module 11 of the server side device 1 gathers and computes, by means of a processing unit, the exchangeable points being collected and exchanged with regard to a plurality of the shop accounts D21 by the customer U by means of the consumption side device 3 to update the exchangeable points included in the customer point information D32 of the customer account D31. In other words, the server side device 1 updates the exchangeable points D321 specialized for each of the shop accounts D21, which are included in the customer point information D32 of the customer account D31. In a preferred embodiment, the shop side device 2 further includes a consumption amount inputting module 23, and the computing module 11 of the server side device 1 updates the exchangeable points D321 specialized for the shop account D21, which are included in the customer point information D32 of the customer account D31, according to a consumption amount of the customer account D31 inputting in the consumption amount inputting module 23 by a shop B and according to the information of collecting and exchanging point D22 of the shop account D21 of the shop B.

In a preferred embodiment, the consumption side device 3 further includes a point transforming module 34 for having the customer U executing a point transforming action, by means of the point transforming module 34, that transforms, based on the exchangeable points included in the customer point information D32 of the customer account D31, the exchangeable points D321 specialized for one of the shop accounts D21 into the exchangeable points D321 specialized for another of the shop accounts D21. Specifically, the customer U can click a point transforming member 341 of the main menu (FIG. 3A) and than select the exchangeable points and the shops between which the exchangeable points are transferred, so as to execute the point transforming action (FIG. 3G). Also, the point transforming record can be displayed on the consumption side device 3 (FIG. 3H). For having the related shops looking over the point transforming record, in addition, the shop side device 2 further includes a point transforming record displaying module 24 displaying a point transforming record information, which is related to the shop account D21 of the shop side device 2, generated by the point transforming action executed by the point transforming module 34 of the consumption side device 3 (FIG. 4B).

In a preferred embodiment, the consumption side device 3 further includes a point sending module 35 for having the customer U sending, by means of the point sending module 35, exchangeable points of shop D321 included in the customer point information D32 of the customer account D31, through the server side device 1, into the customer point information D32 of another customer account D31. Specifically, the customer U can click a point sending member 351 of the main menu (FIG. 3A) and then input information such as shop's name, sending points, and a donee's count, so as to send the exchangeable points (FIG. 3I). The consumption side device 3 corresponding to the customer count D31 of the donee can display the point sending record (FIG. 3J). In addition, the shop side device 2 further includes a point sending module 25 for having a shop B sending, by means of the point sending module 25, the exchangeable points D321 specialized for the shop account D21 of the shop B, through the server side device 1, into the customer point information D32 of the customer account D31.

In a preferred embodiment, the shop side device 2 further includes a broadcasting module 26 for having a shop B broadcasting a message, through the server side device 1, to the consumption side device 3 by means of the broadcasting module 26. The broadcasting message may be information, as shown in FIG. 4C, for the purpose of achieving broadcast influences.

More preferably, in certain embodiments, the customer U also can look for neighboring shops by a shop displaying member 361, share information to the consumption side device 3 of other customers by an information sharing member 37, receive messages by a message member 38, and return feedback opinion to a collecting-exchanging platform by a publishing member 39 (FIG. 3A). The customer U also can browse the customer point information D32 of the customer account D31 by a point browsing member 322 (FIG. 3K), browse shops' information by a shop browsing member 362, and search the shops B by a shop searching member 362 (FIG. 3L). In addition, the shop B also can observe, by the shop side device 2, the condition of joining or quitting the membership of the shop account D21 with respect to the customer accounts D31 (FIG. 4D).

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A marketing system of collecting and exchanging point, comprising:
a server side device storing a plurality of shop accounts and information of collecting and exchanging point thereof, and storing a plurality of customer accounts and customer point information thereof;
a plurality of shop side devices connected with the server side device through a network, each of the shop side devices being respectively corresponding to one of the shop accounts;
a plurality of consumption side devices connected with the server side device through the network, each of the consumption side devices being respectively corresponding to one of the customer accounts, each of the consumption side devices respectively having a point collecting module and a point exchanging module for having a customer executing a point collecting action by means of the point collecting module and executing a point exchanging action by means of the point exchanging module in exchange for a commodity of the information of collecting and exchanging point, through the server side device, based on exchangeable points included in the customer point information of the customer account,
wherein the server side device gathers and computes the exchangeable points being collected and exchanged with regard to a plurality of the shop accounts by the customer by means of the consumption side device to update the exchangeable points included in the customer point information of the customer account,
wherein the exchangeable points included in the customer point information of the customer account are divided into a plurality of exchangeable points specialized for each of the shop accounts.

2. The marketing system of collecting and exchanging point according to claim 1, wherein the consumption side device further includes a point transforming module for having the customer executing a point transforming action, by means of the point transforming module, that transforms, based on the exchangeable points included in the customer point information of the customer account, the exchangeable points specialized for one of the shop accounts into the exchangeable points specialized for another of the shop accounts.

3. The marketing system of collecting and exchanging point according to claim 2, wherein the shop side device further includes a point transforming record displaying module displaying a transforming record information, related to the shop account of the shop side device, generated by the point transforming action executed by the point transforming module of the consumption side device.

4. The marketing system of collecting and exchanging point according to claim 1, wherein the shop side device further includes a point sending module for having a shop sending, by means of the point sending module, the exchangeable points specialized for the shop accounts of the shop, through the server side device, into the customer point information of the customer account.

5. The marketing system of collecting and exchanging point according to claim 1, wherein the consumption side device further includes a point sending module for having the customer sending, by means of the point sending module, exchangeable points of shop included in the customer point information of the customer account, through the server side device, into the customer point information of another customer account.

6. The marketing system of collecting and exchanging point according to claim 1, wherein the point exchanging module automatically executes the point exchanging action in a code scanning manner.

7. The marketing system of collecting and exchanging point according to claim 1, wherein the point collecting module automatically executes the point collecting action in a code scanning manner.

8. The marketing system of collecting and exchanging point according to claim 1, wherein the shop side device further includes a broadcasting module for having a shop broadcasting a message, through the server side device, to the consumption side device by means of the broadcasting module.

9. The marketing system of collecting and exchanging point according to claim 1, wherein the shop side device further includes an exchange setting module for having a shop setting the information of collecting and exchanging point of the shop account of the shop, through the server side device, by means of the exchange setting module.

10. The marketing system of collecting and exchanging point according to claim 1, wherein the shop side device further includes a consumption amount inputting module, and the server side device updates the exchangeable points specialized for the shop accounts, which are included in the customer point information of the customer account, according to a consumption amount of the customer account inputting in the consumption amount inputting module by a shop and according to the information of collecting and exchanging point of the shop account of the shop.
